(19) United States
(12) Patent Application Publication
(10) Pub. No.: US 2013/0117374 A1
(43) Pub. Date: May 9, 2013

(54) Social Network with Blocked Network Users and Accessible Network Users

(71) Applicants: Jean Rene Alexandre Meyer, New York, NY (US); Balazs Alexa, New York, NY (US)

(72) Inventors: Jean Rene Alexandre Meyer, New York, NY (US); Balazs Alexa, New York, NY (US)

(73) Assignee: DMS NETWORK LLC, New York, NY (US)

(21) Appl. No.: 13/291,007

(22) Filed: Nov. 7, 2011

(51) Int. Cl. G06F 15/16

(52) U.S. Cl. 709/205

(57) ABSTRACT

A computer implemented method includes hosting a network service. A secure identifier constituting unreplicated information from a trusted resource is received from a user. The integrity of the secure identifier is verified. Additional identifiers are collected from the user. A blocked network is created. The blocked network constitutes a group associated with the user in at least one other network service that is precluded from accessing the user in the network service. An accessible network is created. The accessible network constitutes a group in the network service that is accessible to the user based upon consistent secure identifiers and additional identifiers. The user is subsequently exposed to the accessible network.

### FIELD OF THE INVENTION

The current invention relates to network communications. More particularly, the invention relates to a social network with blocked network users and accessible network users.

### BACKGROUND OF THE INVENTION

Only a small percentage of internet users interested in online dating actually access an online dating service. This low adoption rate is commonly attributable to perceptions that online dating services are dangerous since they are susceptible to fake profiles. Potential users also have concerns about posting personal data online. Another concern is being seen by friends or family online. Yet another concern relates to perceived inefficiency of finding a partner online compared to finding a partner through a traditional channel.

### SUMMARY OF THE INVENTION

A computer implemented method includes hosting a network service. A secure identifier constituting unreplicated information from a trusted resource is received from a user. The integrity of the secure identifier is verified. Additional identifiers are collected from the user. A blocked network is created. The blocked network constitutes a group associated with the user in at least one other network service that is precluded from accessing the user in the network service. An accessible network is created. The accessible network constitutes a group in the network service that is accessible to the user based upon consistent secure identifiers and additional identifiers. The user is subsequently exposed to the accessible network.

### BRIEF DESCRIPTION OF THE FIGURES

The invention is more fully appreciated in connection with the following detailed description taken in conjunction with the accompanying drawings, in which:

FIG. 1 illustrates a system configured in accordance with an embodiment of the invention.

FIG. 2 illustrates processing operations associated with an embodiment of the invention.

FIG. 3 illustrates the processing of personal identifies and auxiliary identifiers in accordance with an embodiment of the invention.

FIG. 4 illustrates prompts for a secure identifier utilized in accordance with an embodiment of the invention.

FIG. 5 illustrates prompts for additional identifies utilized in accordance with an embodiment of the invention.

FIG. 6 illustrates prompts for privacy settings utilized in accordance with an embodiment of the invention.

FIG. 7 illustrates prompts for selecting an accessible network in accordance with an embodiment of the invention.

FIG. 8 illustrates prompts for additional identifiers utilized in accordance with an embodiment of the invention.

FIG. 9 illustrates prompts for selecting a blocked network in accordance with an embodiment of the invention.

FIG. 10 illustrates preference prompts utilized in accordance with an embodiment of the invention.

FIG. 11 illustrates prompts for personal information utilized in accordance with an embodiment of the invention.

FIG. 12 illustrates access tools utilized in accordance with an embodiment of the invention.

FIG. 13 illustrates a search tool utilized in accordance with an embodiment of the invention.

Like reference numerals refer to corresponding parts throughout the several views of the drawings.

### DETAILED DESCRIPTION OF THE INVENTION

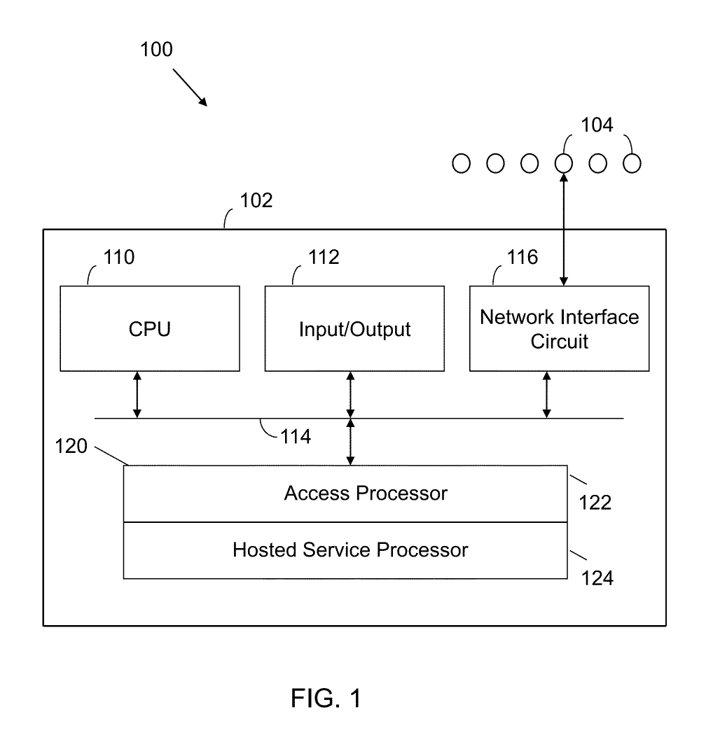

FIG. 1 illustrates a system 100 configured in accordance with an embodiment of the invention. The system 100 includes at least one server computer 102 in communication with a plurality of client devices 104 operative in a networked environment. The server computer 102 includes components, such as a central processing unit 110 in communication with a set of input/output devices 112 over a bus 114. The input/output devices 112 may include a keyboard, mouse, display and the like. A network interface circuit 116 is also connected to the bus 114 to provide networked communications with client devices 104. The networked communications may be wired or wireless communications. The networked communications may include communications with other servers, represented as client devices 104.

A memory 120 is also connected to the bus 114. The memory 120 stores executable instructions to implement operations of the disclosed technology. For example, the memory 120 stores an access processor 122. As discussed below, the access processor 122 defines a blocked network of users and an accessible network of users.

The memory 120 also stores a hosted service processor 124. The hosted service processor 124 includes executable instructions to facilitate social network services, as discussed below.

Each client device 104 includes components, such as a central processing unit, input/output devices, a network interface circuit, and a memory with executable instructions, such as a browser. The client device 104 may be a server computer, a personal computer, a handheld mobile, a tablet, a personal digital assistant and the like.

The configuration of server 102 is exemplary. It should be appreciated that the server 102 may be implemented in any number of configurations, such as with multiple central processing units. Further, the access processor 122 may be distributed across many machines. The hosted service processor 124 may be incorporated into the access processor 122 or may be a separate module, as shown. The configuration of the components of system 100 is insignificant; it is the operations of the disclosed technology, regardless of implementation, that is significant.

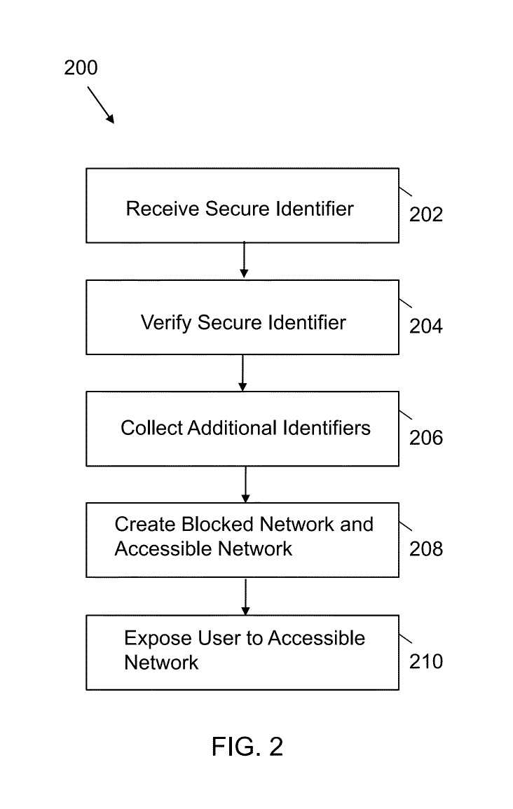

FIG. 2 illustrates processing operations 200 associated with an embodiment of the disclosed technology. These operations are implemented by the access processor 122 and/or the hosted service processor 124. Initially, a secure identifier is received 202. A secure identifier is verified information from a trusted resource. For example, the secure identifier is unreplicated information supplied to a user by a third party that has an incentive to maintain the integrity of the unreplicated information. For example, the secure identifier may be a school email address or an email address issued by an employer.

The next operation of FIG. 2 is to verify the secure identifier. Verifying may include applying the email address against an authentication source. For example, the authentication source may be a Lightweight Directory Access Protocol server controlled by a school or an employer.

Next, additional identifiers are collected 206. The additional identifiers are non-secure identifiers in the sense that they are unverified information from a user, not a trusted resource.

The next operation of FIG. 2 is to create a blocked network and accessible network 208. The blocked network is a group associated with the user in at least one other network service that is proactively precluded from accessing the user in the current network service. The accessible network is a group in the current network that is accessible to the user based upon consistent secure identifiers and additional identifiers.

The final operation of FIG. 2 is to expose the user to the accessible network 210. The exposure may be accompanied by search tools, a message board and other features discussed below.

Thus, the invention provides a reverse social network where users and their social connections are identified and only unknown, potentially trusted people are accessible. Social connections can be real life such as a network of friends at school or online, such as connections on various social networking platforms.

After registration, the technology provides unique, asymmetric subsets of accessible profiles for a user. This may be implemented in three main operations. First, the server 102 may assign a unique Personal Identifier (PID) to a new user based on verified information. In one embodiment, the main PID is the school email address of the user. This first step is necessary to grant or deny access to the platform in a secure manner.

Next, with the help of Network Identifiers (NIDs), social connections to other people and groups of people are identified. Social networks can be mapped based on a variety of information, including but not limited to work, school affiliation, nationality, information from online social networking platforms or contact lists identifying specific individuals. These Network Identifiers may at times be used as a PID to regulate access to the network, and also the other way around, i.e. a PID can be an NID.

The third main step is to provide a platform for asymmetric connections based upon decisions made by a user. Any user has the option to include or exclude its previous social networks or assemble an arbitrary subset of people that have access to a profile. The initial profiles accessible by the user however are the result of myriad decisions taken by other users, as illustrated below.

After signing into the server, all profiles shown the given user are ones that specifically identified that given user as having a set of identifiers fitting the profile owner's privacy settings (e.g. School, Work affiliation, Age, Height, Nationality, etc.). Many NIDs are not user defined but are securely identified by the platform and therefore are not possible to trick. If someone is excluded from a subset defined by another user based on these identifiers, he or she won't be able to access that specific user's profile.

The result of this processing is a variety of subsets that specific users either belong to or not, depending on their Network Identifiers (NID). This concept may be applied to the online origination of any new trusted relationship such as dating, friendships or professional networking.

Thus, the system addresses shortcomings associated with prior technologies. First, the technology is safe. The technology provides a high level of safety through authenticating the identity of every user accessing the platform using identifiers that are impossible or hard to falsify under normal legal circumstances. The technology affords privacy through mapping and excluding social connections, including the user's online and real world social network. Finally, the system is efficient. The system reliably shows only trusted people with similar social, professional backgrounds, or any subset of people that is chosen by the user. A given user can only access the unique subset of profiles that include that specific user through their privacy settings. In other words, everyone seen by a given user already granted access and therefore “wants” to be contacted specifically by that user. Thus, new social connections, such as friendships, dates and professional relationships are established fast and efficiently.

Attention now turns to specific implementations of different embodiments of the invention. A personal identifier (PID) identifies a specific user as a unique person. Thus, a PID has to satisfy the relationship 1 PID=1 real person. The ID cannot be detached from the user as a person and is used to regulate access to the platform.

A Network Identifier (NID) identifies existing or potential relationships between the specific user and other users based on online or real life networks and groups. In other words, NIDs create subsets of people. For instance, a subset can be the {School of Architecture} or {Female}. In this disclosure, identifiers are marked as sets and subsets in the following way:
Identifier input: < >, for instance <University Email>
Top level sets: [ ], for instance [University]
Subsets: { }, for instance {School of Architecture}

So, for example, NID <University Email> links the user to the top level set [University]. A NID can also be used as a PID to varying degrees to identify a person, and in many cases whether an identifier is categorized PID or NID depends on the use case.

Secure identifies identify the person (sPID) or the network (sNID) securely and reliably. That is, they cannot be falsified by a typical user without access to illegal equipment or accessing and using information illegally. We mark secure identifiers with small caps “s” in front of “PID” or “NID”, for instance sPID <University Email> is secure since under normal circumstances it is impossible to falsify a university email address and one person has only one university email address from one university.

Auxiliary identifiers identify the users less securely and may be easily falsified. These include but are not limited to information that is not verified immediately, e.g. age or height. (the identifiers are marked with lower caps “a”, e.g. aPID, aNID)

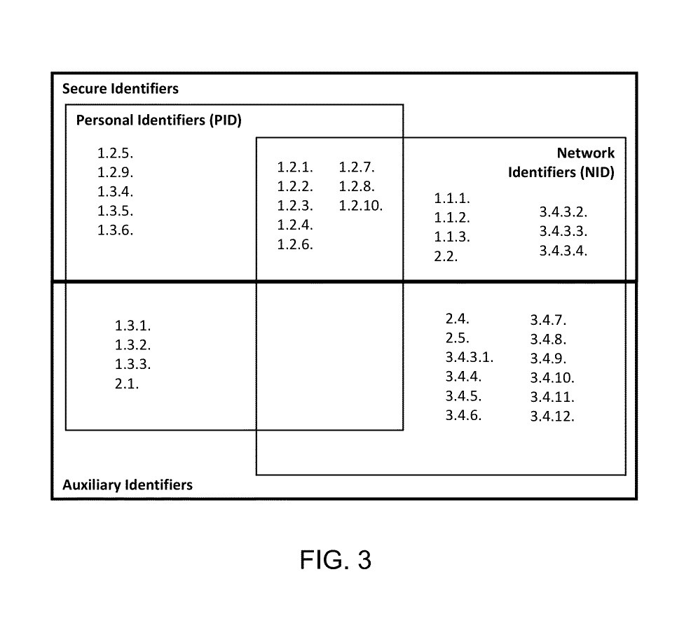

FIG. 3 illustrates exemplary overlap between PIDs, NIDs, secure identifiers and auxiliary identifiers. The specified numbers in the figure (e.g., 1.2.5) have the corresponding example parameters discussed below. In one embodiment, a user selects one of the following secure network identifiers:
1.1.1. sNID <Undergraduate>. Defines the top level set [Undergraduate Students]
1.1.2. sNID <Graduate>. Defines the top level set [Graduate Students]
1.1.3. sNID <Alumn>. Defines the top level set [Alum]

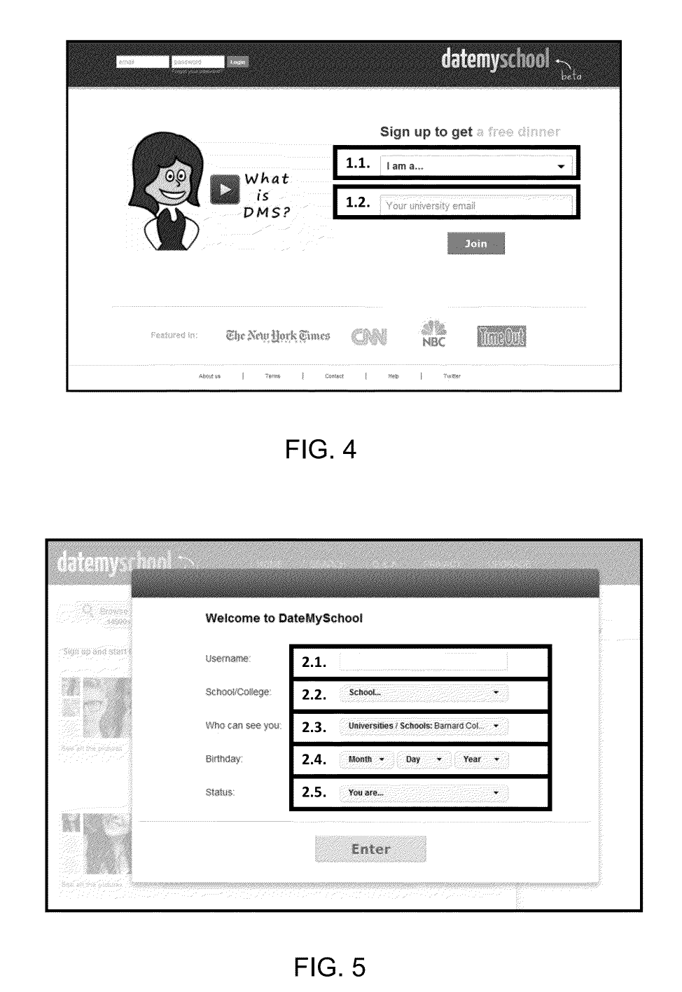

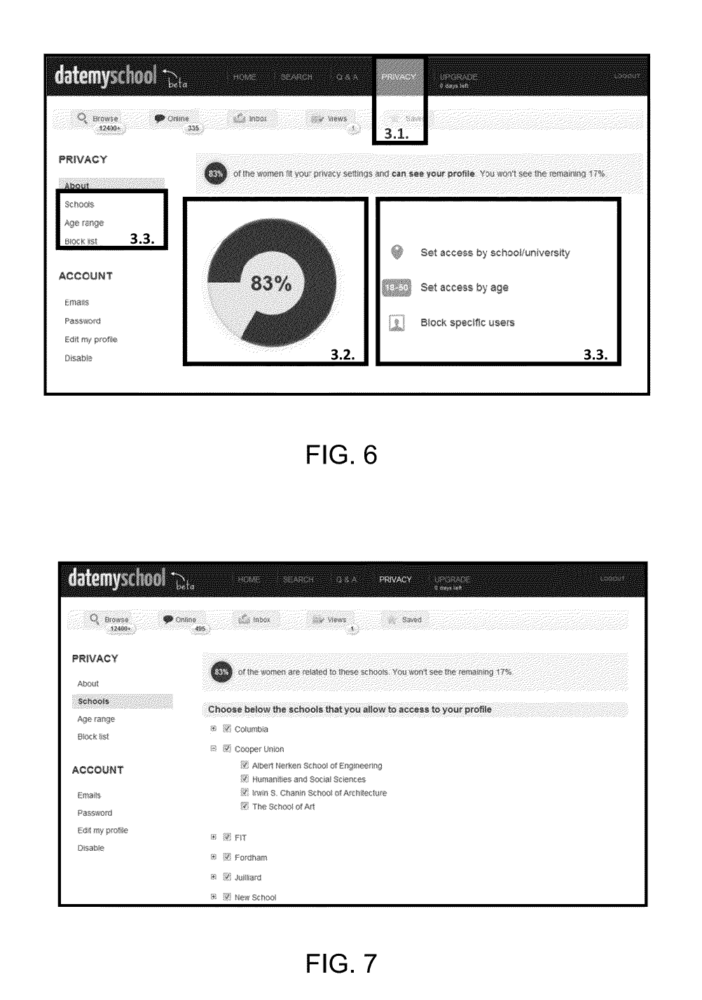

This selection corresponds to operation 202 of FIG. 2. FIG. 4 illustrates an exemplary sign-up page that may be used in accordance with an embodiment of the invention. Element 1.1 of FIG. 4 prompts for student status (e.g., undergraduate, graduate student, post-doctoral student, etc.). Element 1.2 prompts for the school email address. This may result in value 1.2.1. sPID <University Email>, which also serves as sNID defining the set [University]. In one embodiment, users accessing the platform are linked to a specific [University] for example {Columbia University} or {Harvard University} so that they can regulate other users' access to their profile based on university affiliation. Since all users provide this information, it immediately defines a subset of people that may be contacted by the user that is about to sign up. These are not connections as in the case of social networks, but are more like secure permissions granting access to a user, given that all other identifiers (<Age>, <Workplace>, etc) are also satisfied.

The verification operation 204 of FIG. 2 is then performed. In one embodiment, verification is through a school's open Lightweight Directory Access Protocol (LDAP) servers. In particular, the received email address is provided to an LDAP server to confirm affiliation. The following sequence may be followed.
I. The server 102 sends a request to the specific university's LDAP server.
II. The university's LDAP server either confirms the existence of the record and sends back additional information including field of study, department, activity status, graduation year or declines.
III. The server 102 generates a confirmation email sent to the requestor's email address.
IV. The confirmation email contains a unique public key that will be used to generate the unique signup page for the specific user. The process is secure and only accessible by the specific user for security purposes.

The servers may also provide additional information, such as the student's or alum's field or study and department which may be used as sNID. University LDAP servers are openly accessible by anyone. In case the university doesn't have LDAP servers, these identifiers become aNID, i.e. they serve as Auxiliary Network Identifiers.

In another embodiment, [University] is verified through a phone call to the university's Student Office and an official certificate is provided by the university or a degree certificate is provided by the user.

Other secure identifiers may be used in other embodiments of the invention. For example, the following identifiers may be used in accordance with embodiments of the invention.
1.2.2. sPID <Work Email> also serves as sNID that defines [Workplace].
Verification:
   Through workplaces' LDAP servers.
   Confirmation email sent to the specific work email account.
   [Workplace] can be also verified through the Employer via a phone call to the Employer or an official letter by the Employer or the Undersigned Employee Contract provided to the platform.
1.2.3. sPID <Credit Card Number> also serves as sNID that defines [Paying Members].
Verification: through the credit card provider, merchant service, bank relationship (Mastercard, Visa, American Express, etc.). Merchant service also verifies name and address of credit card holder linked to sPID<Credit Card Number>.
1.2.4. sPID <Mobile Phone Number> also serves as sNID defining [Country].
Verification:
   Through verification code sent via Short Message Service (SMS, text message).
   Through a call with customer service.
1.2.5. sPID <Third Party Identifiers: Google Account>
Verification:
   Through Google's API.
1.2.6. sPID <Third Party Identifiers: Gmail Account> also serves as sNID defining [Gmail Contacts]. All contacts are identified that are listed in the user's gmail contact list if the other user is also identified via Google's API.
Verification:
   Through Google's API.
1.2.7. sPID <Third Party Identifiers: Google+Account> also serves as sNID defining [Google+Network]. Every other user that is in the user's Google+Network is verified if the other user is also identified via Google's API.
Verification:
   Through Google's Google+API.
1.2.8. sPID <Third Party Identifiers: Facebook Account via Facebook Connect> also serves as sNID that defines [Facebook Network]. Every other user that is in the user's Facebook Network is verified if the other user is also identified via Facebook's API.
Verification:
   Through the Facebook Connect API.
1.2.9. sPID <Third Party Identifiers: OpenID>
Verification:
   Through the OpenID API.
1.2.10. sPID <Third Party Identifiers: Twitter Account> also serves as sNID that defines [Twitter Followers and Followed]. Every other user that is in the user's Twitter Followers and Followed Network is verified if the other user is also identified via Twitter's API.
Verification:
   Through Twitter's API.

Still other identifiers may be used in accordance with embodiments of the invention, such as:
1.3.1. aPID <IP Address>. With Dynamic Host Configuration Protocol (DHCP) IP addresses are altered every time a user accesses the Internet and even static IP addresses may be hidden if the user is accessing the internet from behind a firewall/LAN. Therefore, this is an Auxiliary Personal Identifier. However, it can help to identify someone when combined with other identifiers.
Verification: IP address is provided by the TCP/IP protocol.
1.3.2. aPID <MAC or Physical Address>. Physical addresses may be altered by someone with root access and are not passed on to server 102 if the user accesses the internet behind a firewall/LAN/router. Therefore, it is an Auxiliary Personal Identifier.
Verification: depending on the operating system, MAC address can be obtained via a specific string.
1.3.3. aPID <PC Application with Unique Identifier: MAC or Physical Address>. Physical addresses may be altered by someone with root access.
Verification: depending on the operating system, MAC address can be obtained via a specific string by the application and passed by to server 102. Since the information is obtained directly from the client, it doesn't matter whether the user accesses the Internet from behind a firewall/LAN.
1.3.4. sPID <Smartphone Application with Unique Identifier>.
Verification: Generated only once for one specific user and is tied to the phone's unique identifier, e.g. serial number of the device or hardware components, if accessible.
1.3.5. sPID <Tablet Application with Unique Identifier>.
Verification: Generated only once for one specific user and is tied to the tablet's unique identifier, e.g. serial number of the tablet or hardware components, if accessible.
1.3.6. sPID <Cookie Markers>.
Verification: Cookies are placed in the user's browser directory and verified by server 102.

Additional identifiers are then collected (operation 206 of FIG. 2). FIG. 5 illustrates prompts for additional identifiers. In this example, the additional identifiers include:
2.1. aPID <Screen Name>. Screen name is chosen by the user and is different from a real name. Preferably, users can only change their screen names once every certain time period (e.g., 3 months) to avoid the creation of phantom profiles. Verification: user defined.
2.2. sNID <Department> creates the set [University Department]. In one embodiment, this information is provided by the LDAP server of the university and therefore is pre-selected for the user. In case a specific university doesn't have LDAP servers the identifier becomes aNID.
Verification:
   sNID <Department>: LDAP of specific university;
   aNID <Department>: user defined and selected from list of schools and departments of the specific university.
2.3. User selects from the sets [University] and [University Department] the entities he or she wishes to have access to a profile.
2.4. aNID <Age> defines the subset [Age] that users can use to grant access to specific age-ranges.
Verification:
   aNID <Age>: user defined.
   sNID <Age>: based on additional documents such as Driver's License, Passport, Birth Certificate independently verified.
2.5. aNID: <Gender> and aNID: <Intention> define sets [Gender] and [Looking For].

In one embodiment, six subsets are defined {Man, Woman}, {Man, Man}, {Man, Both}, {Woman, Woman}, {Woman, Man}, {Woman, Both} based on the selection made by the user.
Verification: user defined.

FIG. 3 illustrates a screen with prompts for auxiliary identifiers, such as privacy identifiers.
3.1. Users set up additional identifiers in the “Privacy” section if they want to set additional identifiers and thus regulate access to their profiles by other users in a more granular manner.
3.2. The platform displays the proportion of users that have access to the specific user's profile based on following:

Permissions set up by the given user during the signup process and in the “Privacy” section's settings.

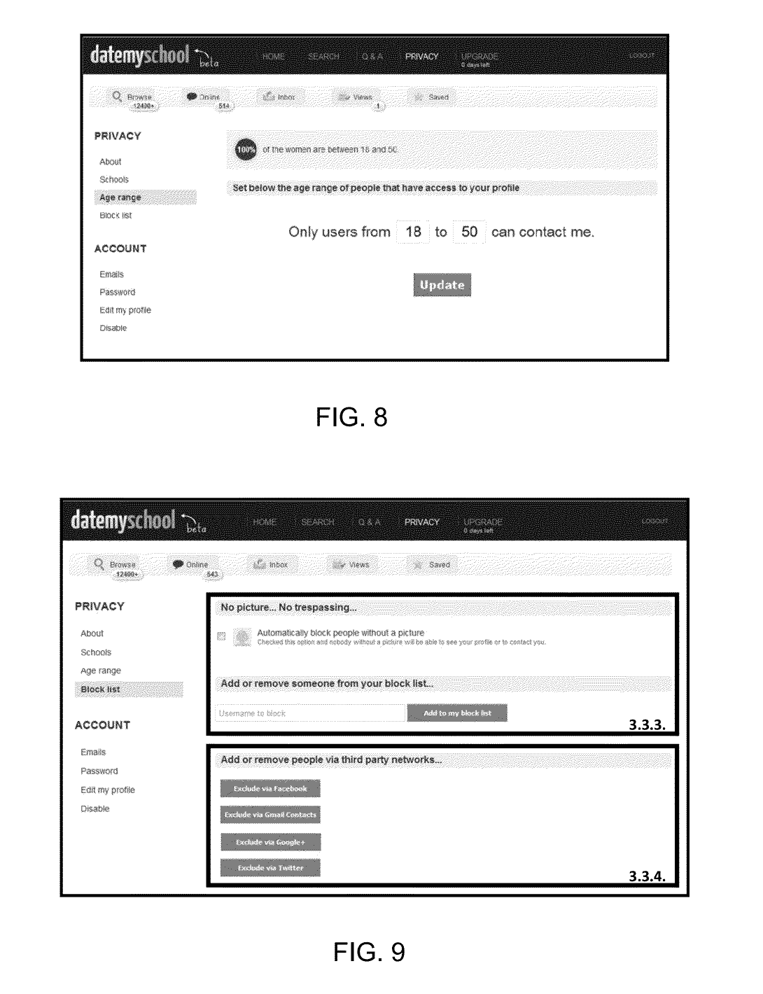

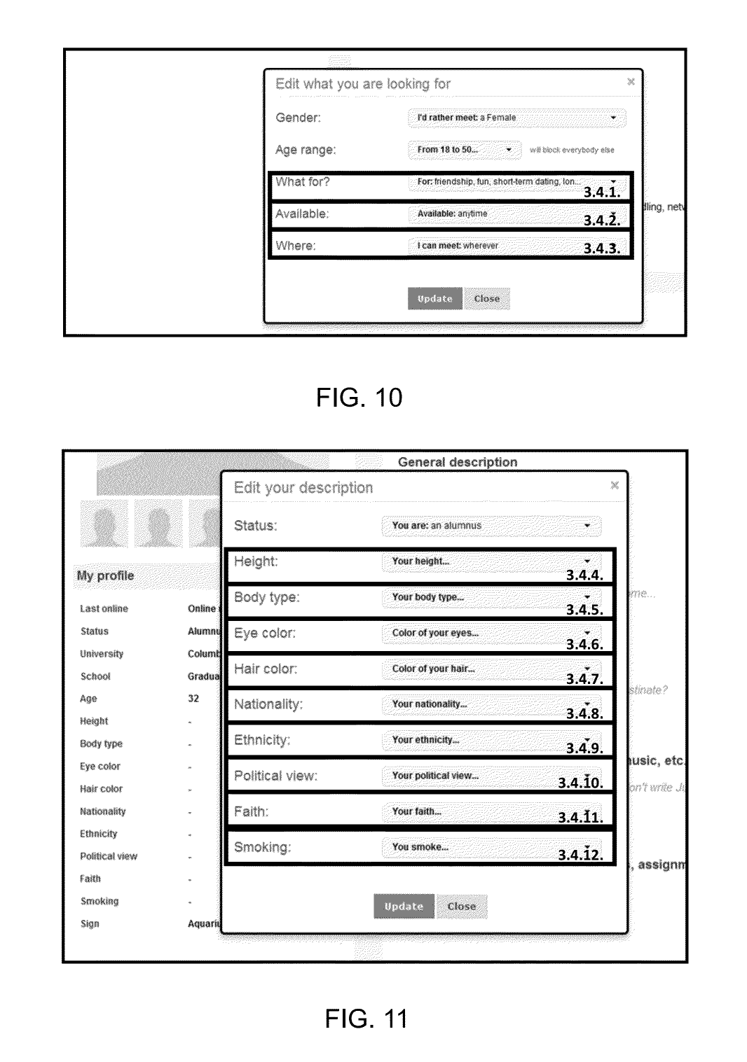

Other users' permissions set up independently from the given user. The latter happens because granting or denying access is symmetrical. FIG. 7 illustrates prompts for selecting schools and departments. Suppose a given user, denoted as ‘user A’ has [University] set to {Harvard University} and another user denoted ‘user B’ belonging to {Boston University} denies access from users belonging to {Harvard University}, ‘user A’ won't be able to access ‘user B's’ profile. In turn, ‘user B’ won't be able to access profiles belonging to {Harvard University} either. Therefore, ‘user B's’ settings decrease the number of people accessible by ‘user A’. All exclusions and inclusions in sets are symmetrical in the same way.
3.3. Additional restrictions to accessing a given user's profile may be based on following sets and identifiers found in the privacy settings:
   3.3.1. [University] and [University Department] based on sNID <University Email> and sNID <Department>. Users may restrict profile access by selecting/deselecting entire universities and their specific departments.
   3.3.2. [Age] based on aNID <Age>. Users are able to specify age ranges that they want to grant/restrict access to their profile. FIG. 8 illustrates prompts that may be used to specify age parameters.
   3.3.3. Users [Without Picture] or specific people based on aPID <Screen Name> can be denied access. FIG. 9 illustrates picture setting parameters. Block 3.3.3 also illustrates that specific individuals may be specified for addition or removal from a blocked network. Observe in this example that the blocked network includes individuals in the hosted network service.
   3.3.4. In addition, [Facebook Network], [Gmail Contacts], Google+ Network] and [Twitter Followers and Followed] can be used also to exclude known people. FIG. 9 illustrates how blocked networks can be selected, e.g., Facebook, Gmail Contacts, Google+ contacts and Twitter followers. In this example, the blocked network is a third-party network. A blocked network may include individuals in the hosted network and/or individuals within a third-party network.
3.4. Additional identifiers may be used to restrict profile access and search for other users. FIG. 10 illustrates appropriate prompts:
   3.4.1. aNID <Intention>, defines [What For] that includes subsets {Friendship}, {Networking}, {Dating}, etc. Verification: user defined.
   3.4.2. aNID <Availability>, defines [Available] that includes subsets {Anytime}, {Now}, {In a week}, etc. Verification: user defined.
   3.4.3.1. aNID <IP Address>, 3.4.3.2. sNID <Wifi Location>, 3.4.3.3. sNID <Mobile Tower>, 3.4.3.4. sNID <GPS Coordinates> define [Proximity]. Verification:
      User defined.
      aNID <IP Address>: IP addresses can be mapped geographically and provide location with varying degrees of reliability.
      sNID <Wifi Location>: Using wifi network if accessing website through a desktop computer, mobile phone or any device where wifi is enabled.
      sNID <Mobile Tower>: Using GSM, 3G, 4G tower identifiers combined with a database containing location of the towers in case the platform is accessed through a device connecting to a tower.
      sNID <GPS Coordinates>: GPS coordinates in case the platform is accessed through a device that enables tracking of GPS coordinates and the data is accessible.

FIG. 11 illustrates personal identifiers:
3.4.4. aNID <Height> that defines [Height]. Verification: user defined.
3.4.5. aNID <Body Type> that defines [Body Type]. Verification: user defined.
3.4.6. aNID <Eye Color> that defines [Eye Color]. Verification: user defined.
3.4.7. aNID <Hair Color> that defines [Hair Color]. Verification: user defined.
3.4.8. aNID <Nationality> that defines [Nationality]. Verification: user defined.
3.4.9. aNID <Ethnicity> that defines [Ethnicity]. Verification: user defined.
3.4.10. aNID <Political View> that defines [Political View]. Verification: user defined.
3.4.11. aNID <Faith> that defines [Faith]. Verification: user defined.
3.4.12. aNID <Smoking> that defines [Smoking Habit]. Verification: user defined.

Many of the above identifiers can be used besides creating subsets and restricting profile access also to search for users belonging to one or more of these subsets.

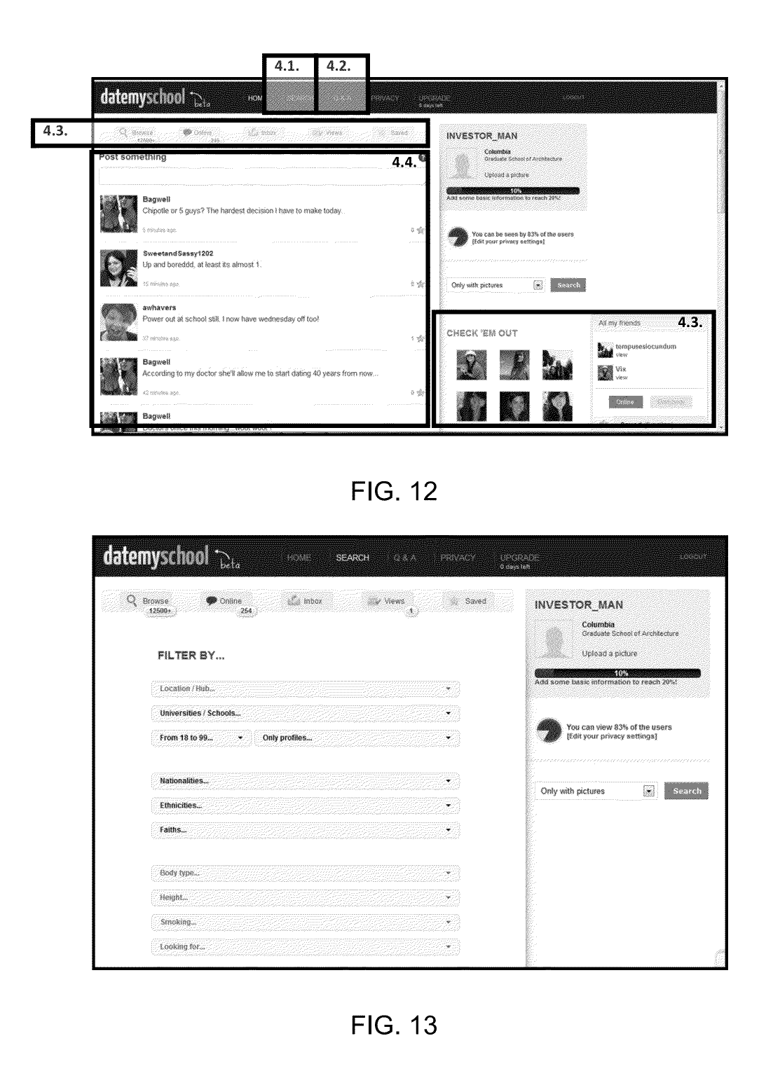

FIG. 12 illustrates various tools that may be exposed to a user after the registration process. Tool 4.1 provides a search facility. Tool 4.2 provides a question and answer facility. Tool 4.3 provides different search parameters. FIG. 13 illustrates additional search filtering parameters that may be used in accordance with embodiments of the invention.

Search results follow the structure of the given users' identifiers, subsets and privacy settings in combination with other users' settings, identifiers and subsets.

Users are free to post questions and answer questions already in the database.

In one embodiment, access to answers is regulated on two levels:
According to users identifiers/subsets.
Any user that wants to access the answers of another user needs to answer the same question. In one embodiment, answers can only be changed periodically, (e.g., every 24 hours).

Features such as browsing profiles, enumerating users currently online, message inbox, profile views from other users, profile suggestions, chat and saving profiles are all based on the identifiers/subset the given user is included into by other users, and the privacy settings of the given user.

The Message Board is a communication stream where users post messages reaching immediately and simultaneously the subset of all people corresponding to their NIDs and privacy settings. It is asymmetric in the sense that when someone responds with another post, not all users will receive the response that saw the original message, and there will be users receiving the response that didn't see the original message.

An embodiment of the present invention relates to a computer storage product with a computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA®, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer implemented method, comprising;
hosting a network service;
receiving from a user a secure identifier constituting unreplicated information from a trusted resource;
verifying the integrity of the secure identifier;
collecting additional identifiers from the user;
creating a blocked network constituting a group associated with the user in at least one other network service that is precluded from accessing the user in the network service;
creating an accessible network constituting a group in the network service that is accessible to the user based upon consistent secure identifiers and additional identifiers; and
exposing the user to the accessible network.

2. The computer implemented method of claim 1 wherein receiving includes receiving an email address.

3. The computer implemented method of claim 2 wherein verifying includes applying the email address against an authentication source.

4. The computer implemented method of claim 3 wherein the authentication source is a Lightweight Directory Access Protocol server.

5. The computer implemented method of claim 3 further comprising collecting additional information about the user from the authentication source.

6. The computer implemented method of claim 3 further comprising sending a confirmation email with a key to the user.

7. The computer implemented method of claim 6 further comprising using the key to generate a signup page for the user.

8. The computer implemented method of claim 1 wherein the secure identifier is selected from a school email address and an employer email address.

9. The computer implemented method of claim 1 wherein the secure identifier is selected from a credit card number, a mobile phone number, and a third party identifier.

10. The computer implemented method of claim 1 wherein the additional identifiers include unsolicited identifiers.

11. The computer implemented method of claim 10 wherein the unsolicited identifiers are selected from an Internet Protocol Address, a Physical Address, an application with a unique identifier and a cookie marker.

12. The computer implemented method of claim 1 wherein the additional identifiers include solicited identifiers.

13. The computer implemented method of claim 12 wherein the solicited identifiers are selected from a screen name, department affiliation, age and gender.

14. The computer implemented method of claim 1 wherein exposing includes providing a search tool.

15. The computer implemented method of claim 1 wherein exposing includes providing a question and answer service.

16. The computer implemented method of claim 1 wherein exposing includes providing a message board.

17. The computer implemented method of claim 16 wherein providing includes providing an assymmetric message that is posted in response to a first message, wherein the assymetric message is not received by some users that received the first message and is received by other users that did not receive the first message.
